(19) United States
(12) Patent Application Publication
(10) Pub. No.: US 2025/0308489 A1
(43) Pub. Date: Oct. 2, 2025

(54) COMPACT FOLDING TRAVEL GUITAR

(71) Applicant: Nicholas Dale Moses, Portland, OR (US)

(72) Inventor: Nicholas Dale Moses, Portland, OR (US)

(21) Appl. No.: 19/094,651

(22) Filed: Mar. 28, 2025

Related U.S. Application Data
(60) Provisional application No. 63/571,874, filed on Mar. 29, 2024.

(51) Int. Cl. G10D 3/095; G10D 1/08; G10D 3/04; G10D 3/12

(52) U.S. Cl. CPC G10D 3/095; G10D 1/085; G10D 3/04; G10D 3/12

(57) ABSTRACT

A foldable stringed instrument, such as a guitar, that folds around a neck of the instrument into a stowed configuration such that the strings wrap around a lower end of the neck. The body of the instrument may rotate about the end of the neck. The instrument may include a bridge assembly that translates longitudinally along the body of the instrument during folding and to add and remove tension in the strings. The neck may include string control features that protect the strings in the stowed configuration and control the strings while transitioning the instrument between configurations.

### PRIORITY APPLICATIONS

Any and all applications for which a foreign or domestic priority claim is identified in the Application Data Sheet as filed with the present application are hereby incorporated by reference under 37 CFR 1.57. This application claims the priority benefit under 35 U.S.C. § 119 (e) to U.S. Provisional Patent Application No. 63/571,874, filed Mar. 29, 2024, entitled “COMPACT FOLDING TRAVEL GUITAR,” the content of which is hereby expressly incorporated by reference in its entirety.

### BACKGROUND

### Field

The present disclosure relates generally to stringed musical instruments, and more particularly, to stringed musical instruments, such as a guitar, that are capable of folding to assume a reduced profile for ease of transport and/or compact storage.

### Description

Stringed instruments, such as guitars, have been some of the most popular musical instruments. Most stringed instruments include a solid, elongate neck that is rigidly coupled to a hollow or solid body of a predefined shape associated with said instrument. The standard construction of said instruments, while allowing for a predictable quality of play and tuning, makes the instruments difficult to transport. For example, a standard guitar or a cello may be restricted from common transportation modes like commercial air travel due to the size.

Some stringed instruments have been designed to have a more compact size for travel or storage. Some stringed instruments are simply scaled down versions of the standard counterparts, which can still present challenges for travel and can affect quality of play or tuning. Some other stringed instrument designs can require a highly inconvenient assembly and disassembly every time the instrument is being transported, sometimes requiring additional tools that need to be transported along with the instrument. The repeated process of assembly and disassembly can lead to damage of the strings or the body due to the complexity of the mechanisms involved. Furthermore, the production of said instrument designs may be highly complex due to numerous moving components, and thus requiring much higher precision and costs.

### SUMMARY

In some aspects, a foldable stringed instrument is disclosed. The foldable stringed instrument may include a neck assembly. The neck assembly may comprise a rigid neck comprising an upper portion coupled to a set of strings, a lower portion, a front surface facing the set of strings, and a back surface opposite the front surface. The set of strings may be configured to wrap around a lower end of the rigid neck when the instrument is folded from a playing configuration into a stowed configuration. The foldable stringed instrument may further include a body assembly. The body assembly may include a body coupled to the lower portion of the neck at a pivot point. The body may be configured to rotate about the pivot point towards the back surface of the neck to fold the instrument. The body assembly may further include a bridge assembly coupled to the set of strings and configured to translate along a longitudinal axis of the body as the instrument is folded.

The bridge assembly may be configured to linearly translate along the body to selectively loosen or tighten the set of strings. The body may comprise a frame with a slot extending along one or both sides of the frame. The slot may be configured to receive a sliding feature of the bridge assembly to allow for translation of the bridge assembly along the frame. The neck assembly may further include one or more string control features arranged at the lower end of the neck assembly. Each of the one or more string control features may be configured to receive and hold a string of the set of strings when the instrument is folded. The body assembly may further comprise a transition tension mechanism configured to apply a transition tension to the set of strings while the instrument is folded and kept in the stowed configuration. The transition tension applied to the set of strings may be enough to keep the set of strings taut within the one or more string control features. The one or more string control features may comprise a plurality of grooves formed in a bottom surface of the neck. The neck may comprise a pivot pin extending out of each side of the lower portion of the neck at the pivot point. The body may be pivotably coupled to the pivot pin on each side of the neck. The body may comprise a first mating feature configured to mate with either of a second mating feature or a third mating feature of the neck to secure the instrument in either of the playing configuration or the stowed configuration, respectively. The first mating feature may comprise a male feature, and both of the second mating feature and the third mating feature may comprise a corresponding female feature. The second mating feature and the third mating feature may be arranged on the lower portion of the neck on opposing sides of the pivot point. The body assembly may further include a bridge tension mechanism arranged on the body. The bridge tension mechanism may be configured to engage the bridge assembly in the playing configuration to maintain a playing tension in the set of strings. The bridge tension mechanism may be configured to disengage from the bridge assembly to release the playing tension before folding the instrument.

In some aspects, a foldable stringed instrument is disclosed. The foldable stringed instrument may include a neck assembly. The neck assembly may include a neck comprising an upper portion coupled to a set of strings, a lower portion, a front surface facing the set of strings, and a back surface opposite the front surface. The foldable stringed instrument may further include a body assembly. The body assembly may include a body coupled to the neck at a pivot point and comprising at least one mating feature. The body may be configured to rotate about the pivot point towards the back surface of the neck to fold the instrument from a playing configuration to a stowed configuration. The body assembly may further include a bridge assembly coupled to the set of strings. The bridge assembly may be configured to translate along the body in a first direction as the instrument is folded. The body assembly may further include a transition tension mechanism configured to apply a transition tension to the set of strings when the instrument is folded. The transition tension in the strings may cause the at least one mating feature of the body to automatically mate with a corresponding mating feature of the neck to secure the instrument in the stowed configuration.

The set of strings may be configured to wrap around a lower end of the neck when the instrument is folded from the playing configuration into the stowed configuration. The neck assembly may further include one or more string control features arranged at the lower end of the neck assembly, each of the one or more string control features configured to receive and hold a string of the set of strings when the instrument is folded. The transition tension applied to the set of strings may be enough to keep the set of strings taut within the one or more string control features. The body may comprise a frame with a slot extending along one or both sides of the frame. The slot may be configured to receive a sliding feature of the bridge assembly to allow for translation of the bridge assembly along the frame. The transition tension mechanism may comprise a spring arranged within the slot and configured to apply a force on the bridge assembly in a second direction opposite the first direction when the instrument is folded.

### BRIEF DESCRIPTION OF THE DRAWINGS

Exemplary features of the present disclosure, its nature and various advantages will be apparent from the accompanying drawings and the following detailed description of various embodiments. Non-limiting and non-exhaustive embodiments are described with reference to the accompanying drawings, wherein like labels or reference numbers refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 illustrates a front view of a foldable electric guitar in a playing configuration, according to some embodiments.

FIG. 2 illustrates a front view of the foldable electric guitar of FIG. 1 in a stowed configuration.

FIG. 3 illustrates a perspective view of the foldable electric guitar of FIG. 1 in a playing configuration.

FIG. 4 illustrates a perspective view of the foldable electric guitar of FIG. 1 in a stowed configuration.

FIGS. 5A-5D illustrate perspective views of the foldable electric guitar of FIG. 1 at various points during the transition from the playing configuration to the stowed configuration.

FIGS. 6 and 7 illustrate front and back perspective views, respectively, of a neck assembly of the foldable electric guitar of FIG. 1, according to some embodiments.

FIG. 8 illustrates a perspective view of a pivot section of the neck assembly of FIGS. 6 and 7.

FIG. 9 illustrates a bottom view of the pivot section of the neck assembly of FIGS. 6 and 7 including a plurality of string control features.

FIG. 10 illustrates a side view of the pivot section of the neck assembly of FIGS. 6 and 7 including body positioning features.

FIGS. 11 and 12 illustrate front and back perspective views, respectively, of a body assembly of the foldable electric guitar of FIG. 1.

FIGS. 13 and 14 illustrate front and back perspective views, respectively, of a bridge assembly included on the body assembly of FIGS. 11 and 12 of the foldable electric guitar of FIG. 1.

FIGS. 15A and 15B illustrate back views of the bridge assembly of FIGS. 13 and 14 when it is engaged and disengaged, respectively, with a bridge tension mechanism, according to embodiments.

FIG. 16 illustrates a perspective view of the bridge assembly of FIGS. 13 and 14 isolated from the body assembly.

### DETAILED DESCRIPTION

Many musicians desire to bring guitars along when traveling, but the guitars are often cumbersome to travel with and may be restricted on common transportation modes such as air travel. Currently available, fully-functional travel guitar designs typically require either dedicated bags or cases for transportation which count towards baggage limits on common transportation modes, and/or require most or all of the usable space in a standard backpack (e.g., 18″ by 14″ by 8″) or piece of carry-on airline luggage (e.g., 24″ by 16″ by 10″) when stored for transport. Various guitar designs may have features that allow for improved portability, but may come with drawbacks such as a limited reduction in size, highly complex and precise parts prone to damage, inconvenient assembly/disassembly, and/or limited functionality.

Instrument players, such as traveling musical performers or hobbyists, who want to bring a stringed instrument while camping, backpacking, traveling, etc., may benefit from embodiments of the foldable instruments described herein. Musicians who lack space to store a traditional guitar in their home may also benefit from embodiments of the foldable instruments described herein. In each of these cases, embodiments of the foldable instruments disclosed herein may enable a musician to use a stringed instrument in contexts where transporting or storing said instrument would have been impractical or impossible.

This application describes foldable instruments that may allow for a reduced complexity and cost of the instrument due to the reduced amount of precise parts needed for the collapsing mechanism of the instrument. The foldable instruments may provide a transitioning mechanism without requiring an inconvenient assembly or disassembly of pieces every time the instrument is transitioned from a playing configuration to a stowed configuration. The foldable instruments may provide comparable playing functionality to a corresponding standard size instrument. The foldable instruments may allow for the use of any common electronic accessories used with a standard instrument to provide a fully functional instrument. For example, with respect to electric guitars, modern digital electronic signal processing may allow for any electric guitar signal to be modulated to mimic the traditional tones of full-size hollow electric guitar bodies, specific electric guitar effects modules and amplifiers, acoustic guitars, etc. that a musician may prefer.

Disclosed herein are embodiments of a foldable stringed instruments. In the primary illustrated embodiment, the foldable stringed instrument is a guitar, although the principles may be applied to other stringed instruments. The foldable stringed instrument may include a neck assembly. The foldable stringed instrument may include a body that may move about a lower end of the neck assembly. The foldable stringed instrument may be configured to reduce in size by allowing the body of the instrument to stow around the neck assembly and for strings of the instrument to wrap around the lower end of the neck assembly. The foldable stringed instrument may include a folding mechanism for folding the instrument into a stowed configuration and unfolding the instrument into a playing configuration. The foldable stringed instrument may further include string control features to protect the strings from damage when in the stowed configuration and when transitioning between the playing and stowed configurations. The foldable stringed instrument may further include positioning features for securing the body of the guitar to the neck in the playing configuration and/or the stowed configuration. The foldable stringed instrument may further include a translating bridge that connects the strings to the body and translates along the body of the instrument when transitioning between the playing and stowed configurations. The foldable stringed instrument may further include a tensioning feature for adding and removing string tension for proper playing functionality as well as ease of transition between playing and stowed configurations.

In some embodiments, the foldable stringed instrument may comprise a foldable electric guitar. The foldable electric guitar may include a minimal body design to allow for a fully-functional guitar that is small enough when stowed to occupy a fraction of the volume of a typical backpack or piece of carry-on luggage used for air travel, allowing for more convenient transportation. The approximate overall dimensions of the disclosed foldable guitar when in the stowed configuration may be approximately 18″ long by 4″ wide by 2.5″ deep, while the dimensions of a traditional guitar may be about 30″-40″ long by 12″-15″ wide by 2″-6″ deep.

Although several embodiments are described herein with respect to an electric guitar, the disclosed features may be used for other stringed instruments such as acoustic guitars, ukeleles, violins, violas, cellos, upright basses, mandolins, electric or acoustic bass guitars, sitars, lutes, or other traditional stringed instruments. Although several embodiments are described herein with respect to a guitar with 6 strings, the disclosed features may be used for an instrument with a different number of strings than the traditional counterpart instrument.

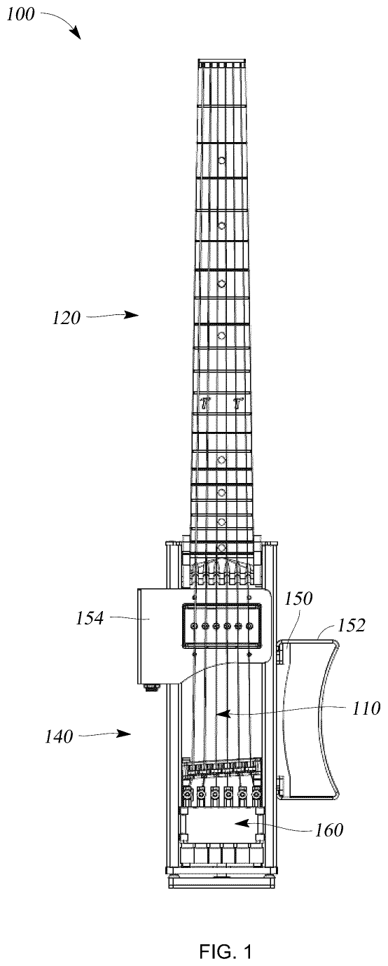

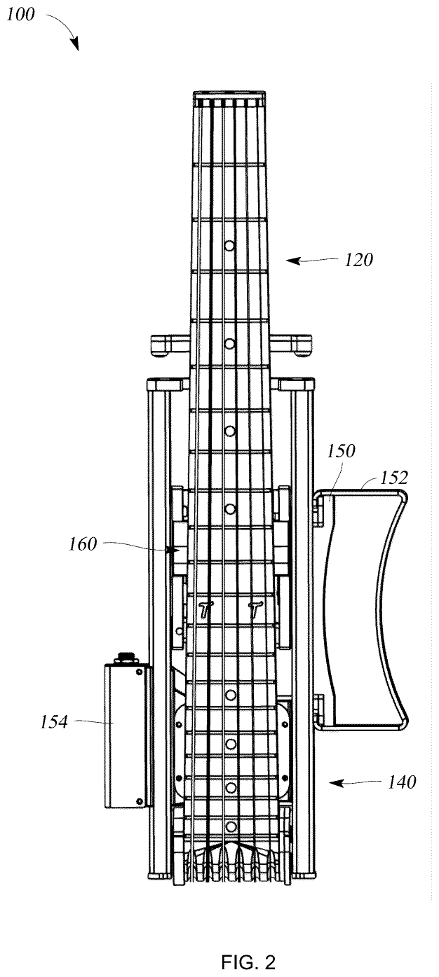

FIGS. 1 and 2 illustrate front views of a foldable electric guitar 100 in a playing configuration (FIG. 1) and a stowed configuration (FIG. 2). In the illustrated embodiment, the electric guitar 100 includes a neck assembly and a body assembly. The neck assembly may comprise a neck 120 and the body assembly may comprise a body 140. The neck 120 may be a long, slender piece of the guitar 100 extending upward from the body 140. The body 140 may be coupled to the neck 120. The guitar 100 may further include a bridge assembly 160 coupled to the body 140. The electric guitar 100 may include a set of guitar strings 110 extending from an upper portion of the neck 120 to the bridge assembly 160. The body 140 may be coupled to various guitar attachments. For example, the body 140 may be coupled to a leg rest 152 by an attachment feature 150. In some embodiments, the attachment feature 150 may be used for attaching a guitar strap. The body 140 may be coupled to an electric guitar pickup 154 configured to capture the vibrations of the strings. As illustrated in FIGS. 1 and 2, the electric guitar 100 may be headless, such that the guitar 100 does not include a head including tuning components. However, in some other embodiments, the neck 120 may extend from the body 140 to a head.

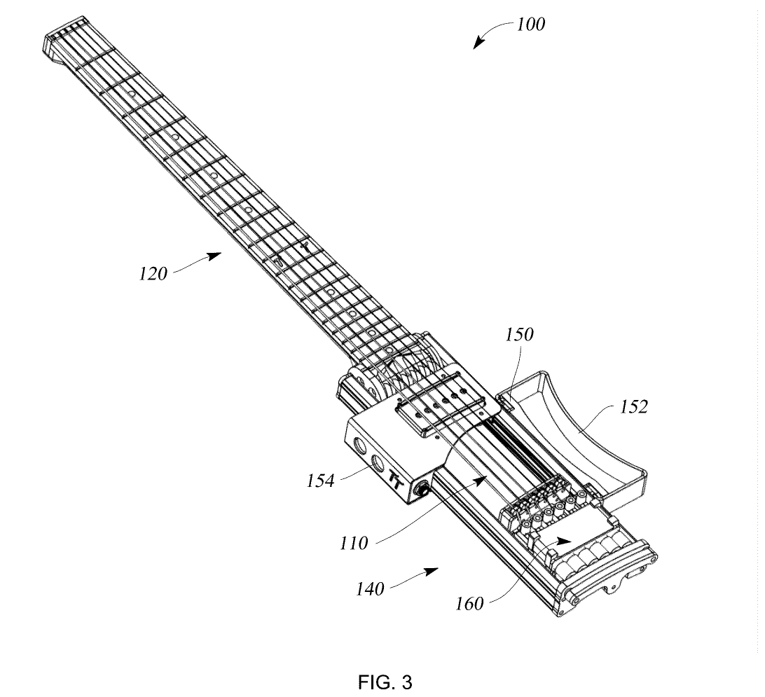

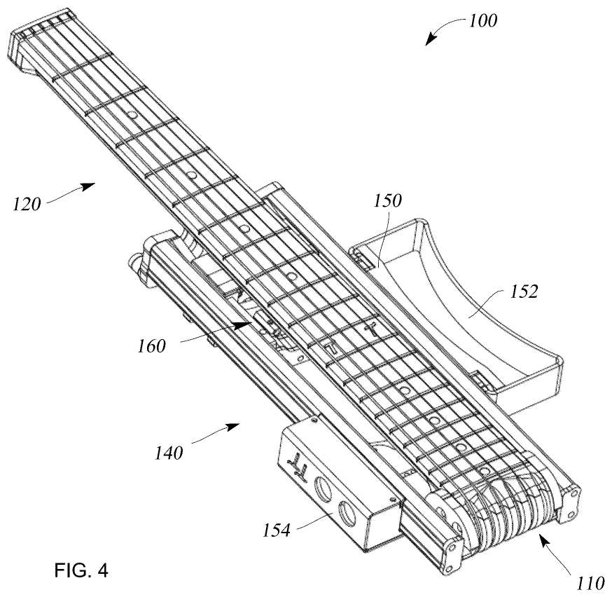

FIGS. 3 and 4 illustrate perspective views of the foldable electric guitar 100 in a playing configuration (FIG. 3) and a stowed configuration (FIG. 4). As is apparent comparing FIGS. 3 and 4, the body 140 of the guitar 100 may be folded toward the neck 120. The body 140 of the guitar may be configured to pivot about a lower portion of the neck 120. The body 140 may rotate about a pivot point arranged on the neck 120 towards a back surface of the neck 120 to fold the guitar 100. When the guitar is folded, the strings may be configured to wrap around a lower portion of the neck 120. For example, as shown in FIG. 4, the strings 110 may be configured to wrap around a surface at the lower end of the neck 120. The surface of the lower end of the neck 120 may be rounded to allow for the smooth wrapping of the strings during the folding of the guitar 100. The folding of the guitar 100 may reduce the length of the guitar 100 by almost the entire length of the body 140. The length of the guitar 100 in the stowed configuration may about the same length as the neck 120, allowing for ease of storage and transport.

### Neck Assembly

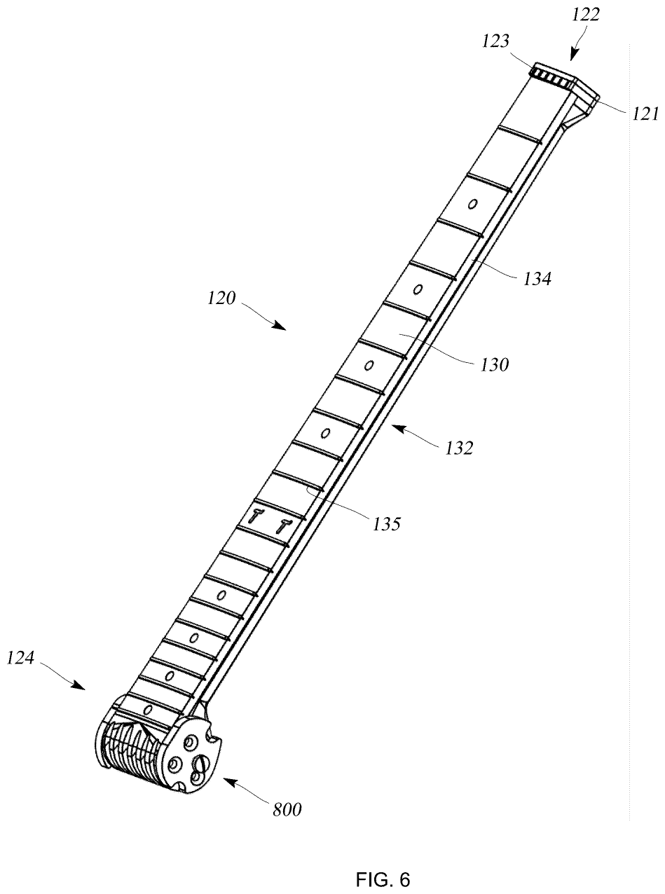

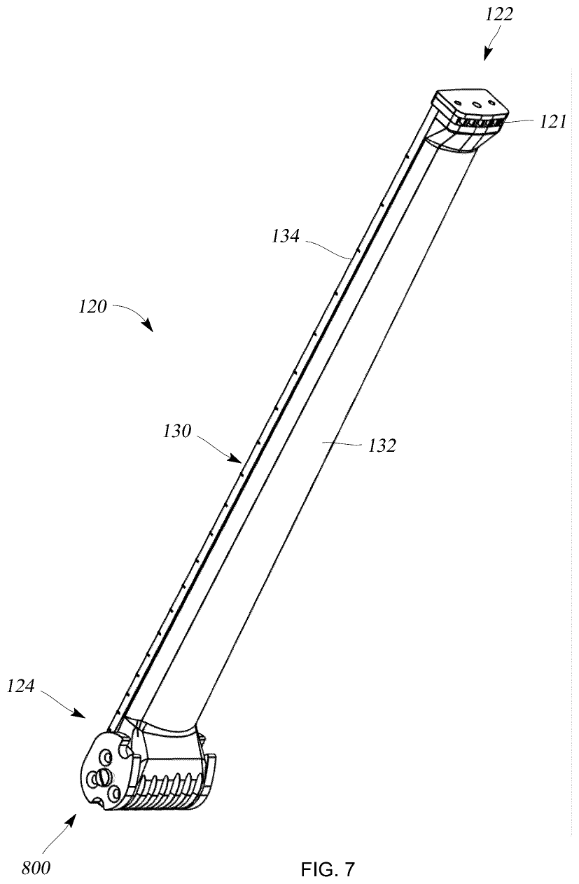

FIGS. 6 and 7 illustrate front and back perspective views of an embodiment of a neck assembly of the foldable electric guitar. The neck assembly may comprise a neck 120. The neck 120 may be a rigid piece that is configured to keep its shape regardless of the configuration of the guitar 100. The neck 120 may not include any hinged portions for the folding of the guitar. The neck 120 may include a front surface 130 and a back surface 132 and left and right side surfaces between the front surface 130 and back surface 132. The front surface 130 of the neck 120 may be facing the strings 110 of the guitar. The front surface 130 of the neck may include a fretboard 134 extending along a majority of the length of the front surface 130 of the neck 120. The fretboard 134 may be a generally flat surface with a plurality of frets 135, which in use, allow a player to create a variety of musical notes by depressing the strings (not shown) between the frets 135. The fretboard 134 may be formed as part of the neck 120. In some embodiments, the fretboard 134 may be coupled to the front of the neck 120 as a separate component. The fretboard 134 may comprise a wooden material, a composite material (e.g., Bakelite or carbon fiber), or some combination thereof. The fretboard 134 may be contoured or grooved at one or both of an upper and lower end of the fretboard 134, such that each of the contours or grooves may receive a guitar string and provide a smooth transition surface for the strings. The fretboard 134 may support the frets 135. The frets 135 may comprise metal or any other material. The neck 120 may comprise a back surface 132. As shown in FIG. 7, the back surface 132 may be rounded, as on a traditional guitar. The back surface 132 may comprise any traditional neck shape, such as a C-shape, a U-shape, a V-shape, a soft V-shape, a D-shape, an asymmetrical neck shape, or any other neck shape.

Referring to FIGS. 6 and 7, the neck 120 may include an upper portion 122 and a lower portion 124. The upper portion 122 of the neck 120 may include a string lock 121 for holding one end of each of the strings 110 in place at the upper portion 122 of the neck 120. The string lock 121 may comprise a metallic material, polymeric material, wood, or composites, or some combination thereof. As shown in FIG. 6, the string lock 121 may lie flat against the upper portion 122 of the neck 120, in contrast to typical guitar configurations, wherein the string lock extends above the upper portion of the neck. The string lock 121 may lie almost or fully perpendicular to the strings which extend down the length of neck 120 in the fully assembled instrument. The flat string lock 121 may save space in the guitar by reducing the overall length of the guitar by approximately the length of the string lock. As shown in FIG. 6, the upper portion 122 of the neck 120 may be free of any tuning components of the guitar. However, in some embodiments, the upper portion 122 of the neck 120 may include a number of tuning components that allow the strings to be tuned. The neck 120 may also have a nut 123 arranged on the upper portion 122 of the neck 120. The nut 123 may comprise a plurality of slots that each receive a string of the set of guitar strings (not shown in FIGS. 6 and 7). The nut 123 may guide each of the strings extending from the string lock 121 and may keep each of the strings in line as they pass over the front surface 130 of the neck 120 and the frets 135 of the electric guitar 100. The nut 123 may comprise a metallic material, bone, a composite material, a plastic material, a synthetic material, or some combination thereof. In some embodiments, the nut 123 may be replaced or complimented by a zero fret placed at the upper portion 122 of the neck 120.

The neck 120 may include a truss rod (not shown) internal to the neck. The neck 120 may have a cavity formed within that extends longitudinally along the neck 120 from the upper end towards the lower end, or from the lower end towards the upper end. The cavity may be positioned beneath the fretboard 134 and may receive the truss rod within. The truss rod may provide stabilization of the neck 120 against the tension of the strings and prevent bowing of the neck 120. The truss rod may comprise a metallic material. In some embodiments, the neck 120 may not comprise a truss rod.

The neck 120 may have a standard size and shape of a traditional guitar. For example, the neck 120 may have a length between 10 and 30 inches, such as 15 inches, 20 inches, 25 inches, 30 inches, or a length in a range defined by any of these values, e.g., 18 inches. The neck 120 may comprise a wooden material, a metallic material, carbon fiber, a plastic material, other composites, or some combination thereof.

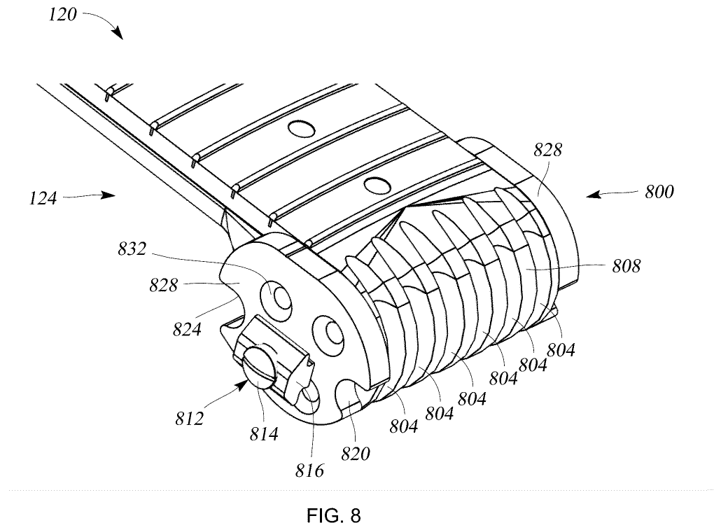

Referring to FIG. 8, the lower portion 124 of the neck 120 may include a pivot section 800. The pivot section 800 may have a larger cross-sectional profile than the rest of the neck 120. As illustrated in FIGS. 7 and 8, the pivot section 800 may have a partially cylindrical shape extending back from the front surface 130. The pivot section 800 may include one or more string control features. The pivot section 800 may further include one or more body positioning features. The body positioning features may include a pivot feature that allows the body to rotate about the neck 120. The body positioning features may include securing features that secure the body to the neck in each of the playing configuration and the stowed configuration and prevent rotation of the body.

The neck assembly may include one or more string control features. The string control features may be configured to manage the strings during the transition of the guitar between playing and stowed configurations. The string control features may prevent the strings from migrating vertically or horizontally during or after folding, which can cause the strings to disengage from the neck and/or expose the strings to damage. For example, the string control features may be arranged on the pivot section 800 at the lower portion 124 of the neck 120. As discussed elsewhere herein, the guitar strings may wrap around the lower portion 124 of the neck 120 when transitioned from the playing configuration to the stowed configuration by folding the guitar (see FIG. 4). The one or more string control features may receive and/or guide the strings while the guitar is transitioned between the playing and stowed configurations. The one or more string control features may hold and protect the strings 110 while the guitar is in the stowed configuration. Each of the one or more string control features may receive one or more strings of the guitar when the guitar is folded into the stowed configuration. The string control features may be formed as part of the lower portion 124 of the neck 120. For example, the string control features may be formed on a surface on the lower end of the neck 120. In some embodiments, the string control features may be coupled to the lower portion 124 of the neck as one or more separate components.

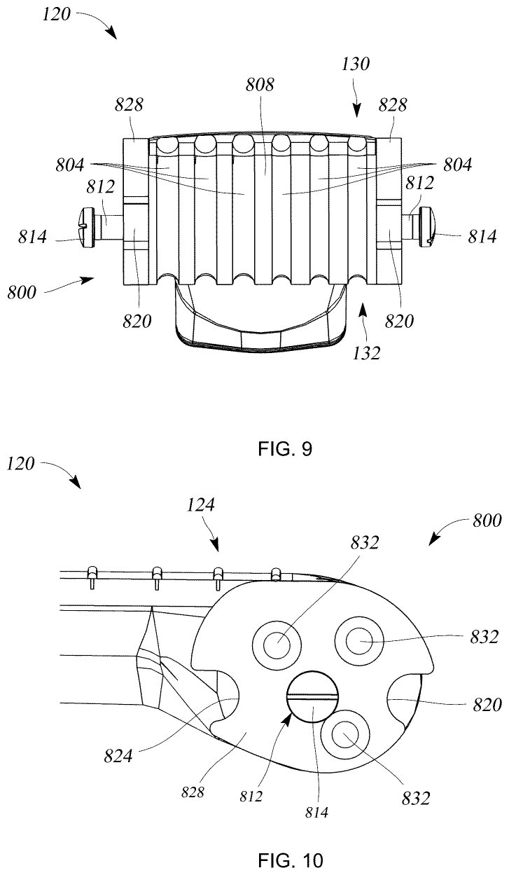

For example, as shown in FIG. 8, the string control features may comprise a plurality of elongate grooves 804 formed on the pivot section 800 of the neck 120. The grooves 804 may be formed on a rounded surface 808 at the lower end of the neck 120. The rounded surface 808 on which the grooves 804 are formed may provide for improved wrapping of the strings around the lower end of the neck 120. As shown by FIG. 9, the grooves 804 may extend from the front surface 130 to the back surface 132 of the neck 120 along a lower end of the neck 120. Each of the grooves 804 may receive an individual string of the set of strings therein when the guitar body is folded about the neck 120 into the stowed configuration (see FIG. 4). In some embodiments, the string control features may comprise notches, pulley wheels, or any other feature configured to receive and hold the strings during a folding transition.

The neck assembly may include body positioning features. The body positioning features may control the position of the body of the guitar relative to the neck. The body positioning features may include a pivot feature that allows the body to rotate about the neck. The body positioning features may further include one or more securing features that secure the body to the neck in each of the playing configuration and the stowed configuration. For example, the body positioning features may be arranged on the pivot section 800 at the lower portion 124 of the neck 120. The body positioning features may be arranged on one or both side surfaces of the pivot section 800 at the lower portion 124 of the neck. The body positioning features may include notches, grooves, rods or threaded studs, compression or clamping components, linear slide mechanisms, or other features which may be formed on the neck 120, or which may be included on additional components made from wood, metal, plastic, composites, etc. that attach to the neck 120. Corresponding features may be included on the guitar body 140 to interface with the body positioning features on the neck 120.

The body positioning features may include a pivot feature on each side of the neck. The pivot feature may define a pivot point on the neck about which the body of the guitar may rotate. The body and the neck of the guitar may be coupled at the pivot feature. The pivot feature may be permanently or removably fixed to the neck on both sides of the neck. The pivot feature may be configured to slide along a longitudinal axis of the body during the transition between playing and stowed configurations and vice versa. The pivot feature may be configured to slide along the body to unlock the body from a securing feature that prevents the body from rotating. In some embodiments, the pivot feature may be coupled to a separate sliding feature of the body that allows for linear sliding motion of the pivot feature within a frame of the body.

For example, as shown in FIGS. 8-10, the pivot feature may comprise at least one pivot pin 812. The pivot pin 812 may be fixed to the neck 120 at the lower portion 124 of the neck 120. As shown by FIG. 8, the at least one pivot pin 812 may be inserted into one or both side surfaces of the pivot section 800 at the lower portion 124 of the neck 120. As shown by FIG. 9, the pivot pins 812 may have a cylindrical shape to allow for smooth rotation of the guitar body around the neck 120. The pivot pin 812 may comprise threads (not shown) to allow the pivot pin 812 to be fixed to the neck 120. The pivot pin 812 may be threaded into corresponding threads formed into the neck 120. The pivot pin 812 may comprise a head 814 that is received by the body 140. For example, the head 814 may be received by a slot formed in a frame of the body, as discussed elsewhere herein. The head 814 of the pivot pin 812 may be coupled to a sliding feature 816 that allows the pivot pin 812 to slide along the body. In some embodiments, the pivot feature may be a rod, threaded stud, or other mechanical component that may be fixed to the lower portion 124 of the neck 120 to allow the guitar body to pivot about the neck 120.

The body positioning features may further include securing features. The securing features may be used to secure the body to the neck in each of the playing configuration and the stowed configuration. The securing features may be mating features configured to mate with and cause a mechanical interference with a corresponding mating feature of the body to prevent the body from rotating about the neck. Each of the securing features may be either a playing position securing feature or a stowed position securing feature, which correspond to securing the body in either of the playing configuration or the stowed configuration, respectively. The neck may comprise at least one playing position securing feature and/or at least one stowed position securing feature. The securing features may be arranged on the side surfaces of the neck. The securing features may be arranged near the pivot feature. The playing position securing feature(s) and the stowed position securing feature(s) may be formed on opposing sides of the pivot feature. The securing features may comprise female features configured to mate with a male feature of the body. In some embodiments, the securing features may comprise male features configured to mate with a female feature of the body.

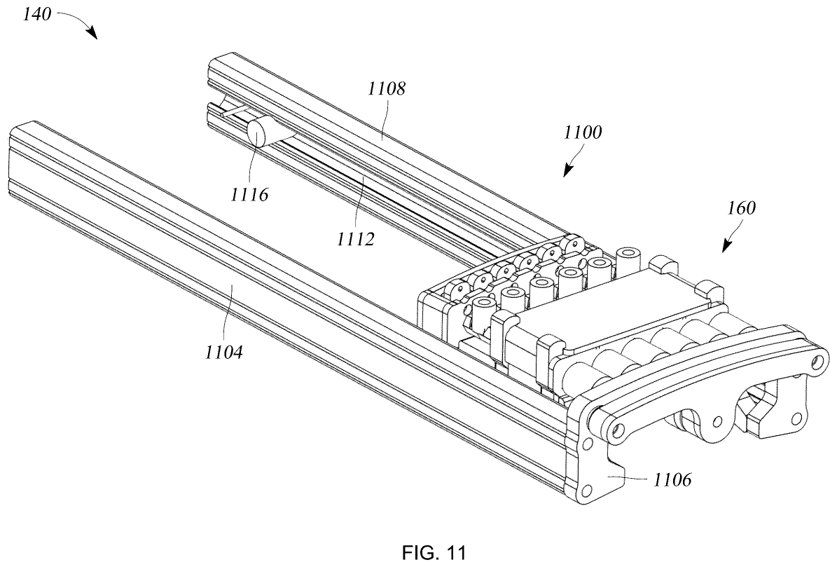

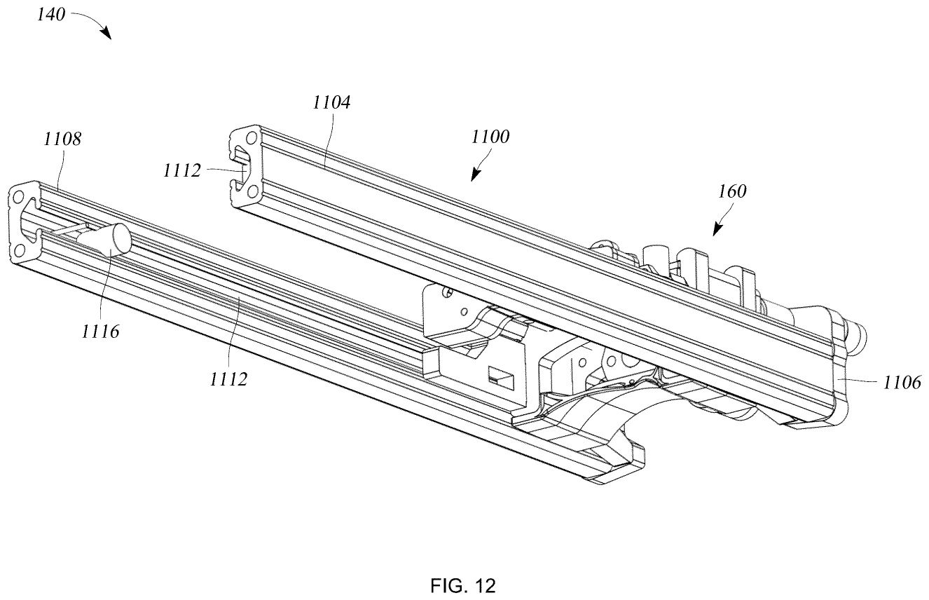

For example, as shown in FIGS. 8-10, the securing features may comprise positioning notches. The positioning notches may be configured to interface and/or mate with a corresponding positioning feature of the guitar body. As shown in FIG. 10, the positioning notches may include a playing position notch 820 and a stowed position notch 824. The playing position notch 820 and the stowed position notch 824 may be arranged on opposing sides of the pivot pin 812. The positioning notches may have an opening facing the upper and lower ends of the neck 120 to allow the notches to receive the corresponding positioning feature of the body from either of an upper or lower side of the neck depending on the configuration. For example, as shown in FIG. 10, the playing position notch 820 may have an opening facing the lower end of the neck 120 and the stowed position notch 824 may have an opening facing the upper end of the neck 120. The corresponding positioning feature of the body may comprise a positioning pin 1116 (see FIGS. 11 and 12). The playing position notch 820 may receive the positioning pin 1116 when the guitar is in the playing configuration. When the guitar is in the playing configuration, the stowed position notch 824 may not have anything received within. The stowed position notch 824 may receive the positioning pin 1116 when the guitar is rotated around the pivot pin 812 and placed into the stowed configuration. When the guitar is in the stowed configuration, the playing position notch 820 may not have anything received within. In some embodiments, the securing features may comprise male features, such as pins or rods, that are configured to interface and/or mate with corresponding female features of the body, such as notches or grooves.

The position securing features may be formed as part of a reinforcing plate arranged on one or both sides of the neck. For example, as shown in FIG. 8, the positioning notches 820,824 may be formed into the plate 828. In some embodiments, the positioning notches may also be formed into the side surfaces of the neck. The plates 828 may be arranged on the side surfaces of the pivot section 800 at the lower portion 124 of the neck. The plate 828 may be permanently or removably attached to the neck 120. The plate may comprise a metallic material, a polymeric material, a composite material, or some combination thereof. The reinforcing plate 828 may interface with the side surface of the pivot section 800. The reinforcing plate 828 may be shaped to match the side surface of the pivot section 800. The reinforcing plate 828 may comprise a hole for inserting the pivot pin 812 therethrough. As shown in FIG. 10, the reinforcing plate 828 may also include one or more fastener holes 832 for receiving fasteners to attach the plate 828 to the side surfaces of the pivot section 800.

### Body Assembly

FIGS. 11 and 12 illustrate front and back perspective views of an embodiment of a body assembly of the foldable electric guitar. The body assembly may comprise a body 140. The body 140 may be coupled to the neck of the guitar. The body 140 may be coupled to the neck at a pivot point on the neck to allow the body 140 to rotate about the neck. The body may comprise a frame 1100. The frame 1100 may be directly coupled to the neck of the guitar at the pivot point. The frame 1100 may be comprised of a metallic material or composite material, or some combination thereof. As shown in FIGS. 11 and 12, the frame may comprise a left arm 1104 and a right arm 1108. In some embodiments, the frame 1100 may comprise one, three, or any number of arms. The left arm 1104 and right arm 1108 may be arranged parallel to each other. As shown in FIG. 11, the left arm 1104 and the right arm 1108 may be connected by a lower arm 1106 at or near a lower end of the frame 1100. The lower arm 1106 may extend in a perpendicular direction to both of the left arm 1104 and the right arm 1108. The lower arm 1106 may lie above, below, or directly between both of the left arm 1104 and the right arm 1108.

The body 140 may comprise a translation mechanism. The translation mechanism may allow for the translation of the body 140 relative to the neck 120 and/or for translation of the bridge assembly 160 relative to the body 140. The translation mechanism may be arranged along the longitudinal axis of the body 140. The translation mechanism may allow for linear translation along the body 140. For example, the translation mechanism may comprise slots arranged along the body 140. The slots may be arranged on the frame 1100. The slots may be arranged on any surface of the frame, e.g., an inner surface, an top surface, a bottom surface, an outer surface. For example, as shown in FIGS. 11 and 12, the frame 1100 comprises a slot 1112 formed on an inner surface of each of the left arm 1104 and the right arm 1108, such that the slots 1112 are facing each other. The slot 1112 may extend along a length of the frame 1100 on which it is arranged. For example, the slot 1112 may extend along the entire length of each of the arms 1104, 1108. In some embodiments, the slots 1112 may not be identical on each side. In some embodiments, the body 140 may comprise a single arm or shaft and the translation mechanism may be arranged along the longitudinal axis of the body.

The body assembly may rotate about the neck to fold the guitar. The frame 1100 may be directly coupled to a pivot point arranged on the neck of the guitar. For example, the frame 1100 may be coupled to the pivot pins 812 (see FIGS. 8-10) of the neck. The pivot pins 812 may define a pivot point or pivot axis about which the frame 1100 may rotate. The pivot pins 812 may be received within the slots 1112 on each side of the frame 1100. The frame 1100, along with the entire body assembly, may rotate about the neck of the guitar. For example, the frame 1100 may rotate towards the back surface of the neck.

The frame 1100 may comprise a positioning feature arranged on one or both sides of the frame 1100. The positioning feature may interface and/or mate with a corresponding securing feature arranged on one or both sides of the neck to secure the body 140 to the neck in each of the playing configuration and the stowed configuration. The positioning feature may be arranged on one or both of the left arm 1104 and the right arm 1108 of the frame 1100. For example, the positioning feature may be arranged within the slots of the frame. As shown in FIGS. 11 and 12, the positioning feature may comprise a positioning pin 1116 arranged within the slot 1112 of the frame 1100. The positioning pin 1116 may be arranged within the slots 1112 on both of the left arm 1104 and the right arm 1108 of the frame 1100. The positioning pin 1116 may interface and mate with the playing position notch 820 (see FIG. 10) to lock the guitar in the playing configuration. The positioning pin may interface and mate with the stowed position notch 824 (see FIG. 10) to lock the guitar in the stowed configuration.

The pivot pin 812 (see FIG. 8) of the neck may be coupled to a sliding feature 816 (see FIG. 8) that is received within the slot 1112 of the frame 1100. Since the pivot pin 812 is fixed to the neck 120, the sliding feature 816 allows for linear sliding motion of the frame 1100 relative to the neck and vice versa. From the playing configuration, the frame 1100 may be pulled away from the neck to disengage the positioning pin 1116 from the playing position notch 820, allowing for rotation of the frame 1100 towards the neck. From the stowed configuration, the frame 1100 may be pulled towards the upper portion 122 of the neck 120 to disengage the positioning pin 1116 from the stowed position notch 824, allowing for rotation of the frame 1100 away from the neck. The frame 1100 may comprise other configurations of slots, grooves, holes, pins, threaded bolts or inserts, clamps, etc., for attaching to the neck and as positioning features for each of the playing and stowed configuration.

The body assembly may include a transition tension mechanism. The transition tension mechanism may be configured to apply a transition tension to the set of guitar strings when the instrument is folded. The transition tension applied to the strings may be enough to keep the strings taut as they are wrapped around the neck and/or while in the guitar is in the stowed configuration. The transition tension may keep the strings taut to keep the strings held within the string control features of the neck, as discussed elsewhere herein. The transition tension mechanism may be arranged on each side of the body. The transition tension mechanism may be internal to the body. For example, the transition tension mechanism may comprise one or more transition springs (not shown) within the slots 1112 on each side of the frame 1100. The transition spring(s) on each side may be arranged between the positioning pin 1116 and the bridge assembly 160. The transition spring(s) on each side may interface with both of the positioning pin 1116 and the bridge assembly 160. The transition springs may apply a force on the bridge assembly 160 in a direction towards a lower end of the frame 1100. The transition springs may comprise metal, composite material, or some combination thereof. The transition springs may ensure that a reduced transition tension (relative to full string playing tension) is placed on the bridge assembly 160 and the strings 110 while transitioning from the playing configuration to the stowed configuration and while in the stowed configuration. The reduced transition tension applied on the strings may be adequate to keep the strings taut and prevent uncontrolled string movement or damage. As the guitar is folded, the transition tension may cause the entire body 140 to be pulled in a direction towards the pivot point on the neck. When the guitar is fully folded, the transition tension pulling on the body 140 may be enough to cause the positioning pin 1116 (shown in FIG. 11) to automatically mate with the stowed position notches 824. The transition tension applied by the springs may be adequate to hold the positioning pins 1116 in the corresponding positioning notches (shown in FIG. 10) in the neck when the guitar is in the stowed configuration. The transition tension may be low enough to not substantially interfere with a human-powered transitioning of the guitar between the playing and stowed configurations. In some embodiments, the transition tension mechanism may include elastic bands or other tensioning mechanisms.

The body assembly may include a neck-body release assist mechanism. The neck-body release assist mechanism may assist in dislodging the positioning feature of the body from the corresponding securing features in the neck before transitioning between playing and stowed configurations. The release assist mechanism may apply a force opposite to the force applied by the transition tension mechanism to reduce the effort required on the part of the user to pull the body frame assembly away from the pivot point between the neck and body. The release assist mechanism may comprise springs, elastic bands, or other tensioning mechanism. For example, the release assist mechanism may comprise release assist springs (not shown) within the slots 1112 on each side of the body frame 1100. The release assist springs may be arranged within the slot between the positioning pins 1116 and the pivot pin 812 (see FIG. 8). The release assist spring may push directly on the pivot pin 812 of the neck that is also within the slot 1112 to provide an assisting force when disengaging the positioning pin 1116 on the body from either of the positioning notches 820/824 on the neck.

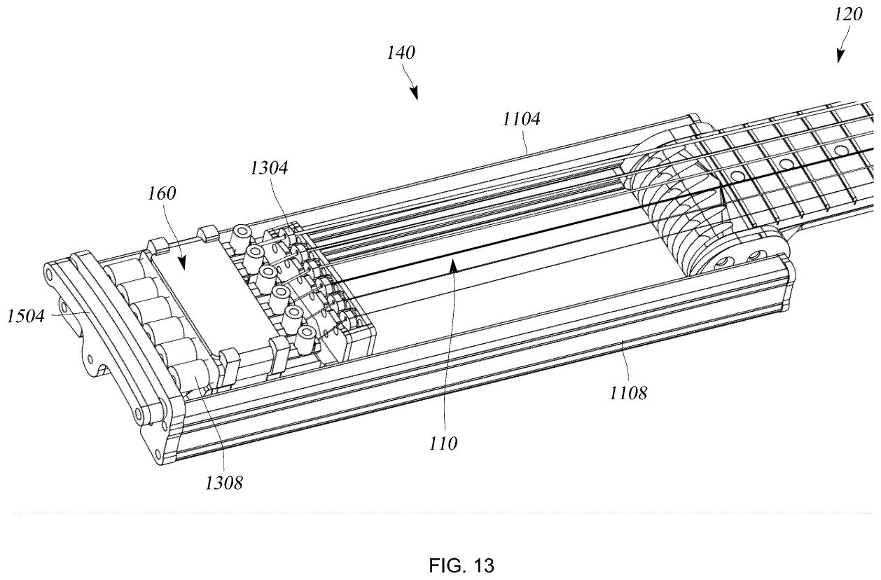

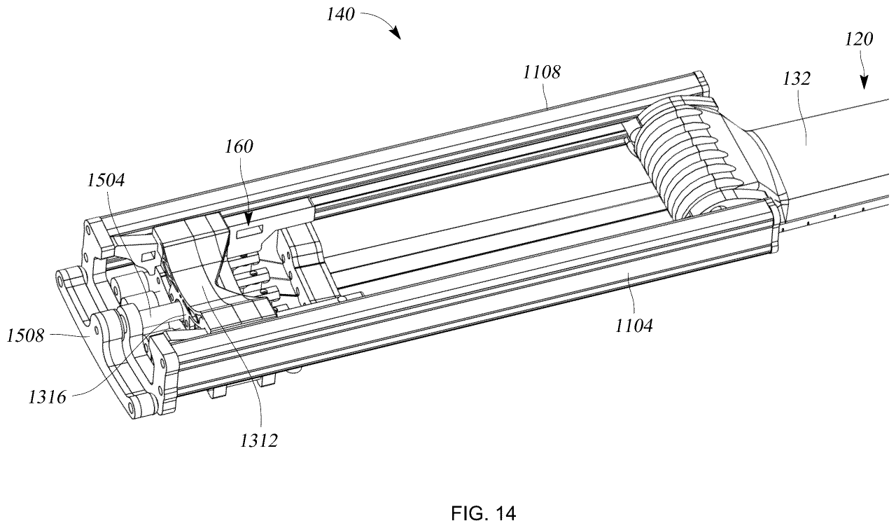

The body assembly may further include a bridge assembly 160. FIGS. 13 and 14 illustrate front and back perspective views of an embodiment of a bridge assembly 160 included on the body assembly. The bridge assembly 160 may be fixed to ends of the strings 110 opposite the ends of the strings fixed to the string lock 121 (see FIG. 6) at the upper portion of the neck. The bridge assembly 160 may hold and apply tension to the strings 110. The bridge assembly 160 may allow a user to selectively tighten or loosen the strings. The bridge assembly 160 may translate along a longitudinal axis of the body 140 to either loosen or tighten the strings. The bridge assembly 160 may be configured for linear motion. For example, the bridge assembly 160 may translate towards the upper end of the body to loosen the strings, and may translate towards the lower end of the body to tighten the strings. For example, the bridge assembly 160 may translate along the frame 1100 in the slots 1112 (see FIG. 11) in the left arm 1104 and the right arm 1108 of the frame 1100. The bridge assembly 160 may translate along the frame 1100 as the guitar transitions between the playing and stowed configurations, as described elsewhere herein. The bridge assembly 160 may include string position adjustment components. The string position adjustment components may hold and secure the guitar strings 110 and may be used to adjust the action of the strings 110. The bridge assembly 160 may include tuning components. The tuning components may be used to adjust the playable string length for tuning of the strings 110 of the guitar.

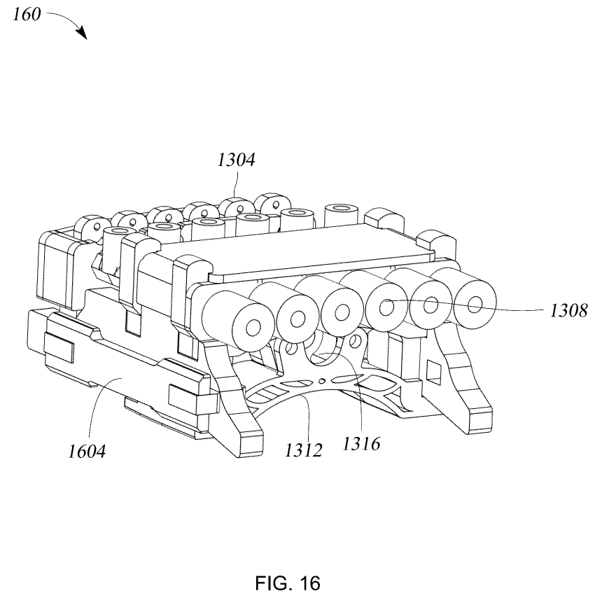

FIG. 16 illustrates a perspective view of the bridge assembly 160 isolated from the body assembly. The bridge assembly 160 may include a translating feature. The translating feature may allow for linear motion of the bridge relative to the frame 1100. For example, the bridge translating feature may comprise one or more sliding features 1604. The sliding features 1604 may have a cross-sectional shape that fits within and interfaces with the cross sectional shape of the slot 1112 (see FIG. 11) in the frame 1100. The sliding features 1604 may interface with the corresponding linear slots 1112 in the frame 1100 to allow for a linear sliding motion. The sliding features 1604 may form a mechanical interference with the slots 1112 of the frame 1100 such that the bridge assembly 1600 remains coupled to the frame 1100 and may only translate in a direction of the slots 1112. The sliding features 1604 may comprise a metallic or polymeric material In some embodiments, the translating feature of the bridge assembly 160 may comprise bearings, tubes, channels, lead screws, or other mechanisms that allow for controlled, linear motion of the bridge assembly 160.

Referring back to FIGS. 13 and 14, the bridge assembly 160 may include a string position adjustment component. The string position adjustment component may comprise a saddle 1304. The saddle 1304 may be a small piece that rests on the bridge assembly 160 and supports the strings 110. The bridge assembly 160 may further include tuning components. The saddle 1304 and the tuning components may allow for the fine adjustment of the playable string length and the action, e.g., the height of the strings above the fretboard. The saddle 1304 may lift the strings 110 to the desired height and transfer the vibration of the strings 110 to the guitar body and pickups. The saddle 1304 may be arranged on the top surface of the bridge assembly 160 near the upper end of the bridge assembly closest to the neck in the playing configuration. The saddle 1304 may comprise individual saddle components that together are referred to as the saddle 1304. For example, the saddle 1304 may comprise six individual saddle components, each holding one string of the set of strings 110. In some embodiments, each saddle component may support two or three strings at a time. The height of the each of the saddle components of the saddle 1304 may be adjustable to set the intonation and the action of the electric guitar. The saddle 1304 may comprise a metallic material, a polymeric material, bone, composite material, or some combination thereof.

The tuning components may be used to finely adjust the playable string length. The tuning components may comprise individual components that together are referred to as the tuning components. For example, the tuning components may be the six pegs 1308 shown in FIG. 13, with each peg associated with one guitar string such that the peg may be turned to adjust the tension of said string. In some embodiments, the tuning components may be arranged in other positions, such as underneath the frame 1100 or at the upper portion 122 of the neck, e.g., on a headstock. The tuning components may comprise a metallic material, a polymeric material, bone, composite material, or some combination thereof.

The bridge assembly 160 may include a neck receiving component. The neck receiving component may be arranged on a back side of the bridge assembly 160 to receive the neck when the guitar is folded into the stowed configuration. For example, as shown by FIG. 14, the bridge assembly 160 may comprise a saddle 1312 to receive the neck 120 and/or interface with the back surface 132 of the neck 120 when the guitar is folded into the stowed configuration. The saddle 1312 may also comprise a threaded insert 1316 that is configured to receive the thumbscrew 1504, as described elsewhere herein.

The body assembly may include a bridge tension mechanism. The bridge tension mechanism may be configured to achieve and maintain a full playing tension to the strings when the guitar is in the playing configuration. The bridge tension mechanism may be configured to engage the bridge assembly to achieve and maintain a tension required to play the guitar, which may be about 100 lb. The bridge tension mechanism may be disengaged from the bridge assembly to release the playing tension to allow the guitar to be folded into the stowed configuration. The bridge tension mechanism may comprise a screw, e.g., a thumbscrew or leadscrew, a lever, cams, worm drives, rack and pinion gears, or other mechanisms to achieve and maintain tension. In some embodiments, the bridge tension mechanism may use leverage to achieve and maintain tension. The bridge tension mechanism may be human-powered or automated.

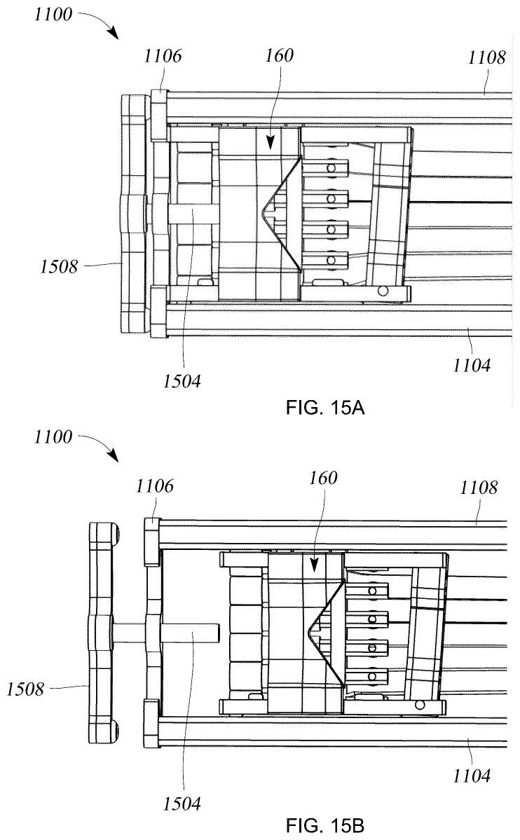

For example, referring to FIGS. 15A and 15B, the bridge tension mechanism may be a thumbscrew 1504. The thumbscrew 1504 may engage with the bridge assembly 160 such that the strings 110 maintain a playing tension required for playing the guitar. The thumbscrew 1504 may be inserted through an opening on the lower arm 1106 of the frame 1100. The thumbscrew 1504 may comprise a handle 1508 for a user to grip when turning the thumbscrew 1504. A user may engage the bridge assembly 160 by screwing, e.g., by turning clockwise, the thumbscrew into a corresponding threaded insert 1316 (see FIG. 14) of the bridge assembly 160. As shown by FIG. 15A, the bridge assembly 160 engaged by the thumbscrew 1504 may be near the lower end of the frame 1100. Disengaging the thumbscrew 1504 may comprise unscrewing, e.g., by turning counterclockwise, the thumbscrew 1504 from the threaded insert of bridge assembly 160. As shown by FIG. 15B, once the bridge assembly 160 is disengaged from the bridge tension mechanism, the bridge assembly 160 may slightly translate along the frame 1100 toward the neck because of the tension released from the strings 110.

### Transitioning Between Configurations

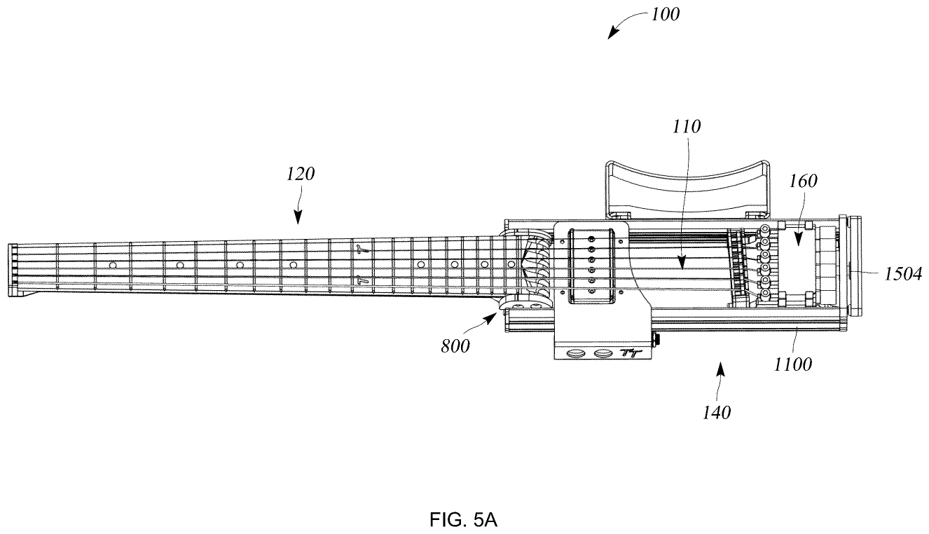

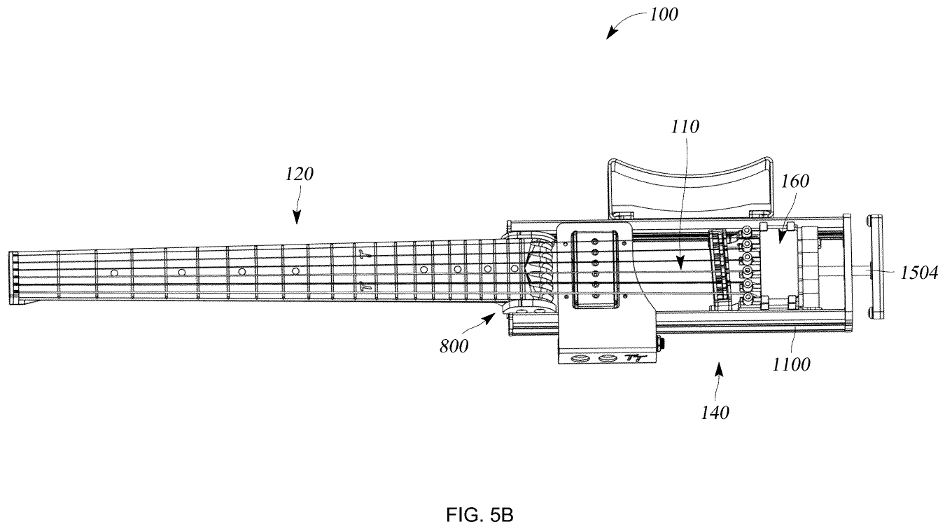

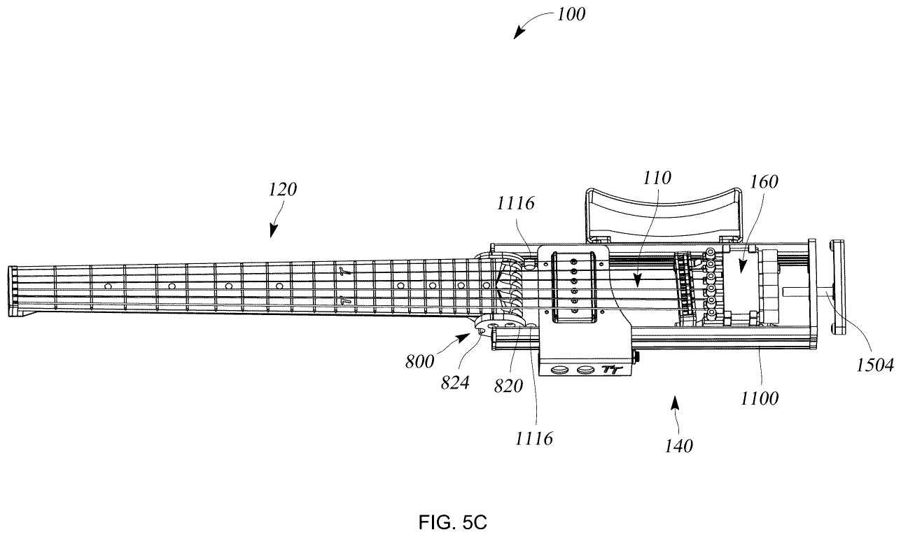

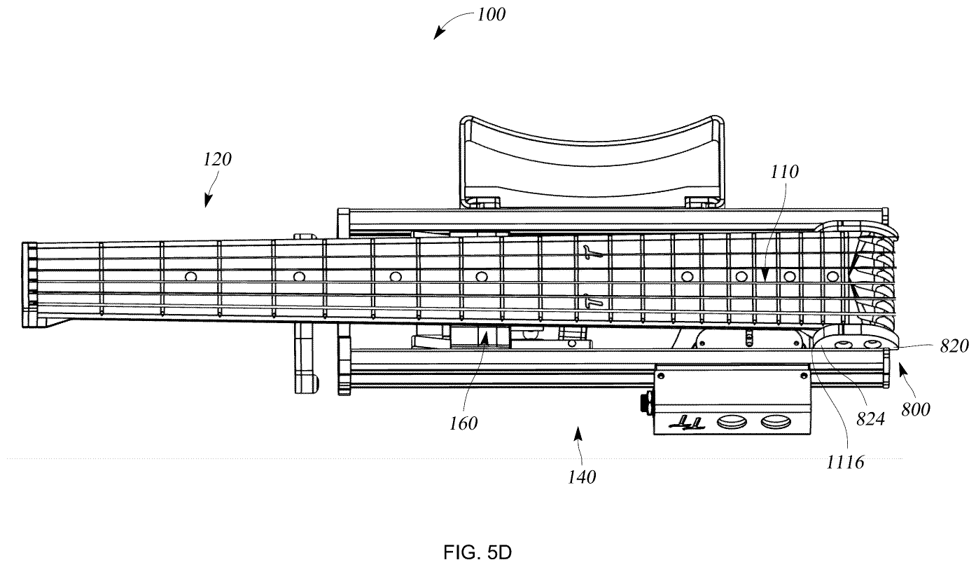

FIGS. 5A-5D illustrate the transition of the foldable electric guitar 100 from the playing configuration (FIG. 5A) to the stowed configuration (FIG. 5D), according to embodiments. The guitar 100 in the playing configuration may have a length of about 20″, 25″, 30″, 35″, 40″, or a length in a range defined by any of these values, e.g., 29″. Transitioning the guitar from the playing configuration to the stowed configuration may comprise disengaging the bridge assembly from the bridge tension mechanism. For example, as shown in FIG. 5B, the thumbscrew 1504 may be turned to unscrew the thumbscrew 1504 from a corresponding insert of the bridge assembly 160. When the bridge assembly 160 is disengaged from the thumbscrew 1504, the bridge assembly 160 may translate along the frame 1100 of the body 140 towards the neck 120 due to the release of tension in the set of strings 110.

Transitioning the guitar 100 from the playing configuration to the stowed configuration may further comprise disengaging the body 140 of the guitar 100 from the neck 120 of the guitar 100. In the playing configuration, the body 140 may be secured to the neck 120 by a securing feature. The securing feature on the neck 120 may interface and/or mate with a corresponding positioning feature of the body 140. For example, the neck 120 may comprise a playing position notch arranged on the lower portion of the neck 120 that interfaces with a positioning pin arranged at the upper end of the body 140. Disengaging the body 140 from the neck 120 may comprise pulling the body 140 away from the neck 120. FIG. 5C illustrates the guitar 100 when the body 140 has been disengaged from the neck 120. For example, as shown in FIG. 5C, pulling the body 140 away from the neck 120 may disengage the positioning pins 1116 on each side of the frame 1100 of the body 140 from the corresponding playing position notch 820 (see FIG. 10) on each side of the pivot section 800 of the neck 120. Disengaging the body 140 from the securing features of the neck 120 in the playing configuration may allow for the body 140 to rotate about a pivot point in the neck 120.

Transitioning the guitar 100 from the playing configuration to the stowed configuration may further comprise rotating the body 140 about the neck 120. The body 140 may be rotated about a pivot point arranged on a pivot section 800 of the neck. The body 140 may be rotated towards the back surface of the neck 120. The body 140 may be rotated by about 180 degrees. The body 140 may be rotated until the body assembly interfaces with the bottom surface 132 of the neck 120. For example, the body 140 may be rotated until the bottom surface 132 interfaces with a saddle 1312 (see FIG. 14) of the bridge assembly 160. As the body 140 is rotated around the pivot point, the bridge assembly 160 may translate along the body 140 in a first direction towards the pivot point. The bridge assembly 160 may be translated toward the pivot point as the strings 110 wrap around the pivot section 800 of the guitar neck 120. The lower surface of the guitar neck 120 may be rounded such that the strings 110 wrap around a rounded lower end of the neck 120. As the body 140 is rotated around the pivot point, springs in the body 140 may apply a transition tension to the strings. The transition tension in the strings 110 may pull the bridge assembly 160 and the body 140 towards the pivot point. Once the body 140 is fully rotated, the positioning feature of the body may interface and/or mate with a securing feature of the neck 120. For example, the positioning pins 1116 in the body 140 may interface and/or mate with separate stowed position notches 824 (see FIG. 10) arranged on each side of the pivot section 800 of the neck 120. The stowed position notches 824 may be different from the playing position notches 820 from which the positioning pins 1116 were disengaged in an earlier step of the transition. The stowed position notches 824 may be arranged on an opposing sides of the pivot point from the playing position notches 820. The positioning pins 1116 may automatically be inserted into the stowed position notches 824 because of the transition tension in the strings 110. The positioning pins 1116 inserted into the stowed position notches 824 may secure the body 140 of the guitar 100 in the stowed position. FIG. 5D illustrates the guitar 100 in the stowed position after the body has been fully rotated about the pivot point and the positioning features, e.g., the positioning pins and corresponding notches, have been engaged to lock the guitar in the stowed configuration. The guitar 100 in the stowed configuration may have a length of about 10″, 15″, 20″, 25″, 30″, or a length in a range defined by any of these values, e.g., 18″.

The steps described with respect to FIGS. 5A-5D may be performed in reverse to transition the guitar 100 from the stowed configuration back to the playing configuration. The body 140 may be disengaged from the pivot section 800 of the neck 120. The body 140 may be rotated about the pivot point and away from the neck 120, such that the strings 110 are unwrapped from the lower end of the neck 120. The body 140 may engage with the playing positioning features of the neck. The bridge assembly 160 may be translated along the body away from the neck 120 and back to the lower end of the body 140. Finally, the bridge assembly 160 may be engaged with the bridge tension mechanism to lock the bridge assembly 160 in place and properly tension the strings 110 for playing.

In some embodiments, the folding stringed instrument may use an electric motor or other powered mechanical assist system for causing the folding of the body about the neck. The foldable string instrument may comprise attachable or fixed features on the body that mimic some or all of the profile of the traditional stringed instrument to improve ergonomics and/or aesthetics. For example, the foldable electric guitar may comprise an attachable and/or removable body feature that mimics the body profile of a standard electric guitar. The body feature may be a leg rest that allows the user to rest the foldable guitar on their leg.

In some embodiments, the foldable stringed instrument may comprise a resonator chamber to amplify the sound made by the strings acoustically. The resonator chamber may be permanently attached to the foldable instrument, or may be removable. In some embodiments, the foldable stringed instrument may comprise integral headphones that are stored in or on the instrument. In some embodiments, the foldable stringed instrument may comprise integral electronics that may convert the signal from the strings to a digital output which may be adjusted for pitch, tone, etc.

In some embodiments, the foldable guitar may comprise one or more additional features that may be used with guitars, such as attachment points for a shoulder strap. The foldable electronic guitar may comprise electronic pickups and circuits to convert and transmit the motion of the strings as an amplified or unamplified electronic signal. The foldable electronic guitar may comprise audio effects circuits to modify or distort the signal. The foldable electric guitar may comprise a speaker to play an amplified version of the notes struck on the strings. These features may be attached to the guitar temporarily or permanently and in preset or variable locations.

Although several embodiments are described herein with respect to an electric guitar, the disclosed features may be used for other stringed instruments such as acoustic guitars, ukeleles, violins, violas, cellos, upright basses, mandolins, electric or acoustic bass guitars, sitars, lutes, or other traditional stringed instruments. Although several embodiments are described herein with respect to a guitar with 6 strings, the disclosed features may be used for an instrument with a different number of strings than the traditional counterpart instrument.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Likewise, the word “connected,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions, and changes in the form of the methods and systems described herein may be made without departing from the spirit of the disclosure. For example, while features are presented in a given arrangement, alternative embodiments may perform similar functionalities with different components and/or sensor topologies, and some features may be deleted, moved, added, subdivided, combined, and/or modified. Each of these features may be implemented in a variety of different ways. Any suitable combination of the elements and acts of the various embodiments described above can be combined to provide further embodiments. The various features and processes described above may be implemented independently of one another or may be combined in various ways. All possible combinations and subcombinations of features of this disclosure are intended to fall within the scope of this disclosure.

What is claimed is:

1. A foldable stringed instrument, comprising:
a neck assembly comprising:
a rigid neck comprising an upper portion coupled to a set of strings, a lower portion, a front surface facing the set of strings, and a back surface opposite the front surface,
wherein the set of strings is configured to wrap around a lower end of the rigid neck when the instrument is folded from a playing configuration into a stowed configuration; and
a body assembly comprising:
a body coupled to the lower portion of the neck at a pivot point, wherein the body is configured to rotate about the pivot point towards the back surface of the neck to fold the instrument; and
a bridge assembly coupled to the set of strings and configured to translate along a longitudinal axis of the body as the instrument is folded.

2. The foldable stringed instrument of claim 1, wherein the bridge assembly is configured to linearly translate along the body to selectively loosen or tighten the set of strings.

3. The foldable stringed instrument of claim 1, wherein the body comprises a frame with a slot extending along one or both sides of the frame, the slot configured to receive a sliding feature of the bridge assembly to allow for translation of the bridge assembly along the frame.

4. The foldable stringed instrument of claim 1, the neck assembly further comprising one or more string control features arranged at the lower end of the neck assembly, each of the one or more string control features configured to receive and hold a string of the set of strings when the instrument is folded.

5. The foldable stringed instrument of claim 4, the body assembly further comprising a transition tension mechanism configured to apply a transition tension to the set of strings while the instrument is folded and kept in the stowed configuration.

6. The foldable stringed instrument of claim 5, wherein the transition tension applied to the set of strings is enough to keep the set of strings taut within the one or more string control features.

7. The foldable stringed instrument of claim 4, wherein the one or more string control features comprises a plurality of grooves formed in a bottom surface of the neck.

8. The foldable stringed instrument of claim 1, wherein the neck comprises a pivot pin extending out of each side of the lower portion of the neck at the pivot point.

9. The foldable stringed instrument of claim 8, wherein the body is pivotably coupled to the pivot pin on each side of the neck.

10. The foldable stringed instrument of claim 1, wherein the body comprises a first mating feature configured to mate with either of a second mating feature or a third mating feature of the neck to secure the instrument in either of the playing configuration or the stowed configuration, respectively.

11. The foldable stringed instrument of claim 10, wherein the first mating feature comprises a male feature, and both of the second mating feature and the third mating feature comprise a corresponding female feature.

12. The foldable stringed instrument of claim 10, wherein the second mating feature and the third mating feature are arranged on the lower portion of the neck on opposing sides of the pivot point.

13. The foldable stringed instrument of claim 1, wherein the body assembly further comprises a bridge tension mechanism arranged on the body and configured to engage the bridge assembly in the playing configuration to maintain a playing tension in the set of strings.

14. The foldable stringed instrument of claim 13, wherein the bridge tension mechanism is configured to disengage from the bridge assembly to release the playing tension before folding the instrument.

15. A foldable stringed instrument, comprising:
a neck assembly comprising:
a neck comprising an upper portion coupled to a set of strings, a lower portion, a front surface facing the set of strings, and a back surface opposite the front surface;
a body assembly comprising:
a body coupled to the neck at a pivot point and comprising at least one mating feature, wherein the body is configured to rotate about the pivot point towards the back surface of the neck to fold the instrument from a playing configuration to a stowed configuration;
a bridge assembly coupled to the set of strings and configured to translate along the body in a first direction as the instrument is folded; and
a transition tension mechanism configured to apply a transition tension to the set of strings when the instrument is folded, such that the transition tension in the strings causes the at least one mating feature of the body to automatically mate with a corresponding mating feature of the neck to secure the instrument in the stowed configuration.

16. The foldable stringed instrument of claim 15, wherein the set of strings is configured to wrap around a lower end of the neck when the instrument is folded from the playing configuration into the stowed configuration.

17. The foldable stringed instrument of claim 16, the neck assembly further comprising one or more string control features arranged at the lower end of the neck assembly, each of the one or more string control features configured to receive and hold a string of the set of strings when the instrument is folded.

18. The foldable stringed instrument of claim 17, wherein the transition tension applied to the set of strings is enough to keep the set of strings taut within the one or more string control features.

19. The foldable stringed instrument of claim 15, wherein the body comprise a frame with a slot extending along one or both sides of the frame, the slot configured to receive a sliding feature of the bridge assembly to allow for translation of the bridge assembly along the frame.

20. The foldable stringed instrument of claim 19, wherein the transition tension mechanism comprises a spring arranged within the slot and configured to apply a force on the bridge assembly in a second direction opposite the first direction when the instrument is folded.
